(19) United States
(12) Patent Application Publication
(10) Pub. No.: US 2018/0043449 A1
(43) Pub. Date: Feb. 15, 2018

(54) SYSTEMS AND METHODS FOR TEXTURING METAL

(71) Applicant: Nous Defions, LLC, Freeport, FL (US)

(72) Inventor: David Pavlick, Freeport, FL (US)

(21) Appl. No.: 15/785,700

(22) Filed: Oct. 17, 2017

Related U.S. Application Data
(63) Continuation-in-part of application No. 15/384,452, filed on Dec. 20, 2016.
(60) Provisional application No. 62/270,434, filed on Dec. 21, 2015.

(51) Int. Cl. B23H 9/00; B05D 3/02; B23K 26/00; F41A 3/14; B05D 3/10; B23K 26/352; B05D 7/14; B05D 3/06

(52) U.S. Cl. CPC B23H 9/008; B05D 7/14; B05D 3/0254; B05D 3/06; F41A 3/14; B05D 3/102; B23K 26/352; B23K 26/0084; C23F 4/04

(57) ABSTRACT

Systems and methods disclosed herein relate to texturing a metal surface. A disclosed method for texturing a metal surface comprises applying a material via a thermal spray to form a textured surface, for example on a firearm slide.

### CROSS-REFERENCE TO RELATED APPLICATIONS

This application is a continuation-in-part of U.S. Ser. No. 15/384,452 filed on Dec. 20, 2016 and entitled “SYSTEMS AND METHODS FOR TEXTURING METAL”, U.S. Ser. No. 15/384,452 claims priority to, and the benefit of, U.S. Provisional Application Ser. No. 62/270,434 filed on Dec. 21, 2015 and entitled “SYSTEMS AND METHODS FOR TEXTURING METAL”. Each of the foregoing applications is hereby incorporated by reference in its entirety for all purposes.

### TECHNICAL FIELD

The present disclosure relates to texturing metal surfaces.

### BACKGROUND

Many metal products feature smooth surfaces. However, this smoothness may be undesirable; for example when a surface is intended for gripping by a hand. Accordingly, to improve the gripping of metal surfaces, textured surfaces may be present on the metal product; improved systems and methods for texturing of metal surfaces remain desirable.

### SUMMARY

The present disclosure provides methods for texturing a metal surface. In an exemplary embodiment, a method for texturing a firearm slide comprises forming a recess in a first surface on the firearm slide, coupling a mask to the firearm slide to cover portions of the firearm slide beyond the recess, applying a material to the recess via a thermal spray process to form a textured surface in the recess, and uncoupling the mask from the firearm slide.

The contents of this summary section are intended as a simplified introduction to the disclosure, and are not intended to be used to limit the scope of any claim.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein:

FIG. 1 illustrates a perspective view of a firearm slide, in accordance with various embodiments;

FIG. 2 illustrates a method for texturing a metal surface by adding media, in accordance with various embodiments;

FIGS, 3A and 3B illustrate a method for texturing a firearm slide by adding media, in accordance with various embodiments;

FIG. 4 illustrates a method for texturing a firearm slide by removing material, in accordance with various embodiments;

FIG. 5 illustrates a method for texturing a firearm slide by removing material, in accordance with various embodiments;

FIG. 6A illustrates approaches for texturing metal utilizing thermal spray in accordance with various embodiments;

FIG. 6B illustrates a cutaway view of a textured surface formed via a thermal spray approach, in accordance with various embodiments; and

FIG. 6C illustrates a view of a pistol slide having a plurality of textured surfaces formed via a thermal spray approach, in accordance with various embodiments.

### DETAILED DESCRIPTION

All ranges and ratio limits disclosed herein may be combined. It is to be understood that unless specifically stated otherwise, references to “a,” “an,” and/or “the” may include one or more than one and that reference to an item in the singular may also include the item in the plural.

The detailed description of exemplary embodiments herein makes reference to the accompanying drawings, which show exemplary embodiments by way of illustration and its best mode, and not of limitation. While these exemplary embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected and/or the like may include permanent, removable, temporary, partial, full and/or any other possible attachment option. Additionally, any reference to without contact (or similar phrases) may also include reduced contact or minimal contact.

As used herein, “aft” refers to the direction associated with the back end of a firearm, or generally, to the direction of recoil when a firearm discharges a projectile. As used herein, “forward” refers to the direction associated with the muzzle, or front end, of a firearm, or generally, to the direction a projectile travels when discharged from the firearm.

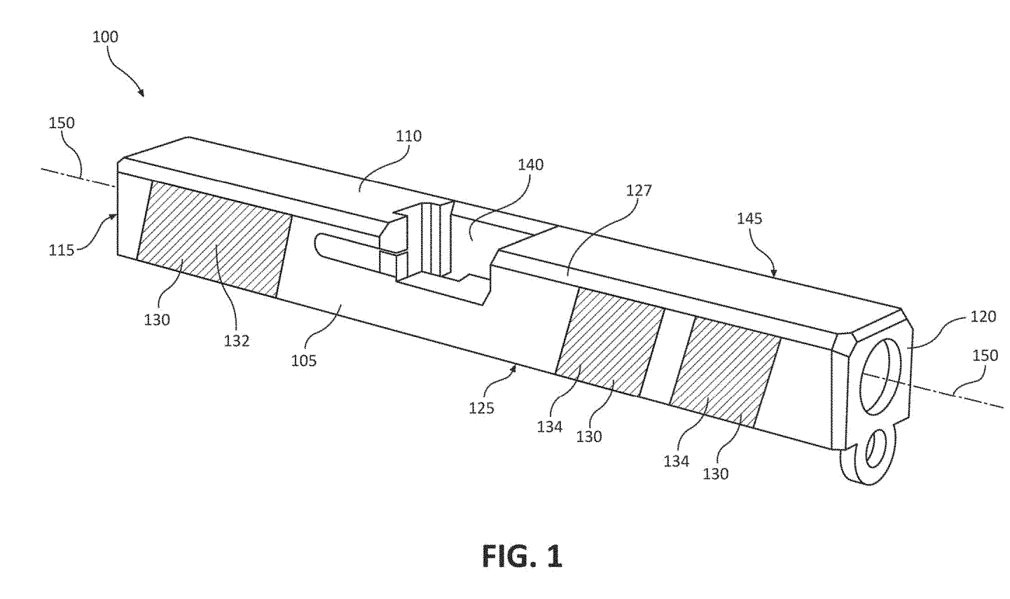

With reference now to FIG. 1, a firearm slide 100 is depicted, in accordance with various embodiments. Firearm slide 100 may be any suitable firearm slide for any suitable firearm. For example, firearm slide 100 may be a semiautomatic pistol slide. Firearm slide 100 is depicted about reference axis 150. A muzzle end 120 of firearm slide 100 may be forward along reference axis 150, and a back end 115 of firearm slide 100 may be aft along reference axis 150. Firearm slide 100 comprises a first slide side 105, a second slide side 145, a slide top side 110, a slide bottom side 125, and/or an ejection port 140. Firearm slide 100 may have a transition surface 127 between first slide side 105 (and/or second slide side 145) and slide top side 110. In various embodiments, firearm slide 100 may have no transition surface 127, and slide top side 110 may couple directly to first slide side 105.

In various embodiments, firearm slide 100 comprises one or more textured surfaces 130. Textured surfaces 130 may be on first slide side 105, second slide side 145, slide top side 110, and/or any other suitable surface or side on firearm slide 100. Firearm slide 100 comprises one or more aft textured surfaces 132 on first slide side 105 and/or second slide side 145. As used herein, aft textured surface 132 may be a textured surface 130 disposed aft of ejection port 140. Firearm slide 100 comprises one or more forward textured surfaces 134. As used herein, forward textured surface 134 may be a textured surface 130 disposed forward of ejection port 140. Textured surfaces 130 may be disposed at the same point along reference axis 150 as ejection port 140. In this regard, textured surfaces may be symmetrically or non-symmetrically disposed on either of first slide side 105 and/or second slide side 145. First slide side 105 comprises the same number of textured surfaces 130 as second slide side 145, or first slide side 105 comprises more or fewer textured surfaces 130 than second slide side 145.

In various embodiments, textured surfaces 130 are recessed from the surface on which they are disposed, For example, textured surfaces 130 may be recessed from first slide side 105 such that the surface of first slide side 105 protrudes radially from reference axis 150 farther than textured surfaces 130. Moreover, textured surfaces 130 may be flush with transition surface 127 and/or slide top side 110. In various embodiments, textured surfaces 130 comprises texturing accomplished through the removal of material comprising firearm slide 100, and/or a material or materials may be applied to the firearm slide 100 to create textured surfaces 130.

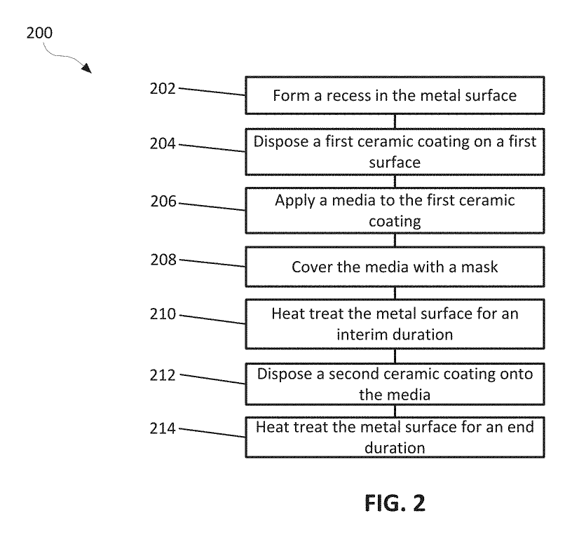

With reference now to FIG. 2, a method 200 for texturing a metal surface by adding media is depicted, in accordance with various embodiments. In various embodiments, a recess may be formed in the metal surface (step 202). The recess may be formed by any suitable method including for example, mill-machining, wire electrical discharge machining (“wire EDM”), and/or the like. The recess comprises a first surface to be textured. The first surface on the metal surface may be prepared by removing all coatings, oils, and/or contaminants. Such preparation comprises cleaning the first surface with a de-greasing chemical and/or heating the first surface, for example to a temperature of approximately 300 degrees Fahrenheit (more generally, between about 270 degrees Fahrenheit and about 330 degrees Fahrenheit). A first ceramic coating may be disposed onto the first surface (step 204). The first surface may be masked off, taped off, or otherwise bounded in order to coat a correct area of the first surface. The first coating may be a firearm coating, for example a ceramic coating sold under the Cerakote® brand, a spray firearm coating sold under the DuraCoat® brand, paint, and/or other suitable coatings or adhesives.

A media may be applied to the first ceramic coating (step 206). The media may be any suitable material comprising particles that will provide a textured surface in response to being applied to the first surface and/or the first ceramic coating. For example, the media may comprise aluminum oxide particles, glass beads, a combination of aluminum oxide particles and glass beads, and/or the like. In various embodiments, the media may comprise a larger percentage of aluminum oxide particles in order to create a less coarse textured metal surface. Conversely, the media may comprise a larger percentage of glass beads to create a coarser textured metal surface. Additionally, the level of coarseness of the textured surface may at least partially be determined by the depth of the recess that may be formed in the metal surface. In response to a greater depth of the recess, the textured surface may be coarser and the media may comprise an increased percentage of glass beads and a decreased percentage of aluminum oxide particles. Conversely, in response to a smaller depth of the recess, the textured surface may be less coarse, and the media may comprise an increased percentage of aluminum oxide and a decreased percentage of glass beads. The coarseness of the texture may be similar to the grit in sand paper. In this regard, the coarseness or roughness may range from approximately 10 grit (e.g., average media particle diameter of approximately 1800 μm) to approximately 600 grit (e.g., average media particle diameter of approximately 25.8 μm) depending on the amounts of media applied to the firearm slide.

In various embodiments, the media may be covered by a mask (step 208). The mask may be an adhesive mask or other suitable mask. The metal surface comprising the first ceramic coating and media may be heat treated for an interim duration (step 210), which may be approximately ten minutes (more generally, between about 9 minutes and about 11 minutes). The metal surface may be heat treated for the interim duration at a temperature of approximately 300 degrees Fahrenheit (more generally, between about 270 degrees Fahrenheit and about 330 degrees Fahrenheit). The mask may be removed from the media. A second ceramic coating may be disposed on the media (step 212). The second ceramic coating may be the same material as the first ceramic coating, or any other suitable material. The metal surface may be heat treated for an end duration (step 214). The heat treating for the end duration may take place after the heat treating for an interim duration. The heat treating for an end duration may be for approximately one hour (more generally, between about 55 minutes and about 65 minutes) or any other suitable length of time, at a temperature of approximately 300 degrees Fahrenheit (more generally, between about 270 degrees Fahrenheit and about 330 degrees Fahrenheit).

With reference now to FIG. 3A, a method 300 for texturing a firearm slide by adding media is depicted, in accordance with various embodiments. Method 300 is similar to method 200 of FIG. 2, but the steps of method 300 may be performed on a firearm slide. With combined reference to FIGS. 1, 3A, and 3B, in various embodiments, a first recess may be formed in the firearm slide 100 (step 302). The first recess may be located where one or more textured surfaces 130 are depicted in FIG. 1, which may be on first slide side 105, or any other side of firearm slide 100. The first recess comprises a first surface to be textured. The first surface on the firearm slide may be prepared by removing all coatings, oils, and/or contaminants. Such preparation may comprise cleaning the first surface with a de-greasing chemical and/or heating the first surface up to approximately 300 degrees Fahrenheit (more generally, between about 270 degrees Fahrenheit and about 330 degrees Fahrenheit). A first ceramic coating may be disposed onto the first surface on first slide side 105 (step 304). The first surface may be taped off or otherwise bounded in order to coat a correct area of the first surface. The first ceramic coating may be a firearm coating described above in the discussion of FIG. 2. A first media may be applied to the first ceramic coating (step 306). The first media may be a media described above in the discussion of FIG. 2.

In various embodiments, the first media may be covered by a first mask (step 308), The mask may be an adhesive mask or other suitable mask. The first surface comprising the first ceramic coating and media may be heat treated for an interim duration (step 310), which may be approximately t10 minutes (more generally, between about 9 minutes and about 11 minutes). Firearm slide 100 may be heat treated for the interim duration at a temperature of approximately 300 degrees Fahrenheit (more generally, between about 270 degrees Fahrenheit and about 330 degrees Fahrenheit). The first mask may be removed from the media. A second ceramic coating may be disposed onto the first media (step 312). The second ceramic coating may be the same material as the first ceramic coating, or any other suitable material. Firearm slide 100 may be heat treated for an end duration (step 314). The heat treating for the end duration may take place after the heat treating for an interim duration. The heat treating for an end duration may be for approximately one hour (more generally, between about 55 minutes and about 65 minutes) or any other suitable length of time, at a temperature of approximately 300 degrees Fahrenheit (more generally, between about 270 degrees Fahrenheit and about 330 degrees Fahrenheit).

In various embodiments, method 300 for texturing a firearm slide may further comprise steps depicted in FIG. 313. A second recess may be formed in the firearm slide 100 (step 320). The second recess comprises a second surface to be textured. The second recess may be formed on first slide side 105, second slide side 145, and/or any other side of firearm slide 100. A third ceramic coating may be disposed onto the second surface (step 322). The third ceramic coating may be the same material as the first ceramic coating and/or the second ceramic coating, or any other suitable material. A second media may be applied to the third ceramic coating (step 324). The second media may be a media described above in the discussion of FIG. 2, and may be the same as the first media. The second media may be covered by a second mask (step 326), which may be an adhesive mask. A fourth ceramic coating may be disposed onto the second media (step 328). The fourth ceramic coating may be the same material as the first, second, and/or third ceramic coating, or any other suitable material.

In various embodiments, the steps of method 300 may be performed on any side of firearm slide 100. In various embodiments, steps 302-308 and/or steps 320-326 may take place before step 310 in method 300. Steps 312 and/or 328 may take place after step 310 and/or before step 314 in method 300.

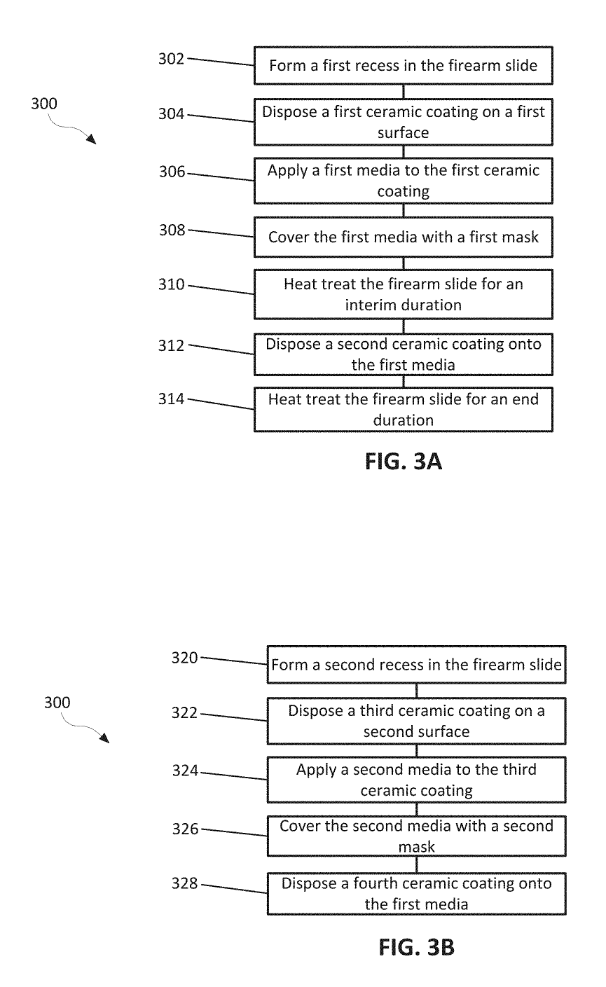

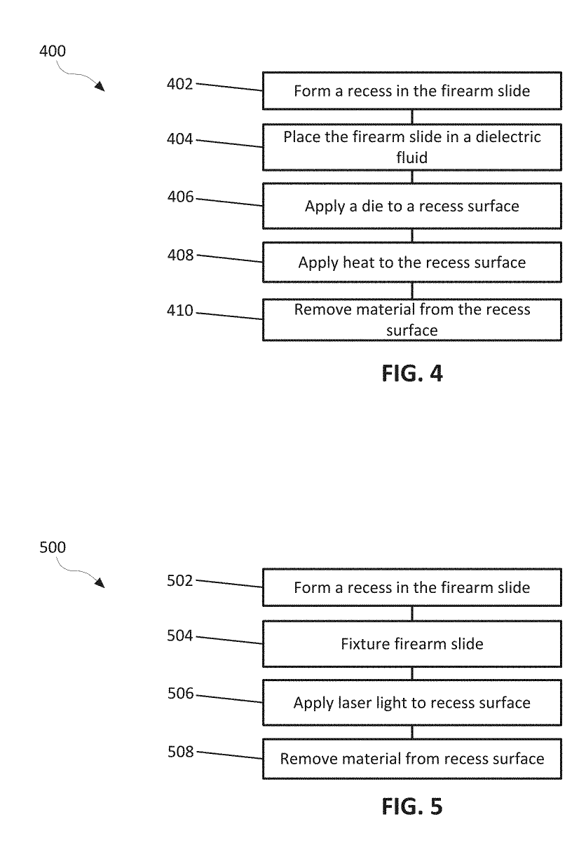

With reference now to FIG. 4, a method 400 for texturing a firearm slide by removing material is depicted, in accordance with various embodiments. With combined reference to FIGS. 1 and 4, in various embodiments, a recess may be formed in firearm slide 100 (step 402) in a slide surface such as first slide side 105. The recess may be formed, for example, in any of the locations of textured surfaces 130 on firearm slide 100, or any other suitable location. The recess in firearm slide 100 comprises a recess surface to be textured. Firearm slide 100 may be placed in a dielectric fluid (step 404). The dielectric fluid may be any fluid capable of preventing or rapidly quenching electrical discharges within the fluid, for example, deionized water. A die is submerged into the dielectric fluid, and applied to the recess surface (step 406). The die may be a piece of metal serving as an electrode. There is an electrical potential between the die and the recess surface, and in response to the die being applied to the recess, an electric spark may travel from the die to the recess surface. The die may never physically touch the recess surface. Heat may be applied to the recess surface (step 408), which may be a result of the electric spark from the die being applied to the recess surface. Material from the recess surface may be removed (step 410) by the heat applied to the recess surface. The described process, including applying heat to the recess surface, may comprise electrical discharge machining. In various embodiments, method 400 may create any desired pattern in the recess surface. A pattern created in the recess surface comprises any desired surface roughness to create a texture in the recess surface.

With reference now to FIG. 5, a method 500 for texturing a firearm slide by removing material is depicted, in accordance with various embodiments. With combined reference to FIGS. 1 and 5, in various embodiments, a recess may be formed in firearm slide 100 (step 502) in a slide surface such as first slide side 105. The recess may be formed, for example, in any of the locations of textured surfaces 130 on firearm slide 100, or any other suitable location. The recess in firearm slide 100 comprises a recess surface to be textured. Firearm slide 100 may be fixtured (step 504) in a specific location and orientation in preparation for texturing. Laser light from a laser may be applied to the recess surface (step 506). The laser may apply laser light at any suitable wavelength, such as at about 10640 nanometers, and at any suitable intensity. The laser may comprise any laser suitable for processing of metal, for example a CO2 laser, a neodymium yttrium-aluminium-garnet (Nd:YAG) laser, and/or the like. In response to the laser light being applied to the recess surface, material from the recess surface may be removed (step 508), in various embodiments, by heat resulting from the light energy of the laser, which may vaporize some of the recess surface material, or by fracturing and flaking of the material resulting from the laser light application. A pattern created in the recess surface may comprise any desired surface roughness to create a texture in the recess surface.

In various embodiments, methods similar to those described that make uses of other metal removal processes, such as any suitable metal etching process are contemplated within the scope of the present disclosure.

This disclosure is described in terms of a firearm slide 100 suitable for a semiautomatic and/or automatic pistol, as depicted in FIG. 1. It should be realized however, that this disclosure may apply to any metal surface and/or firearm surface capable of being textured.

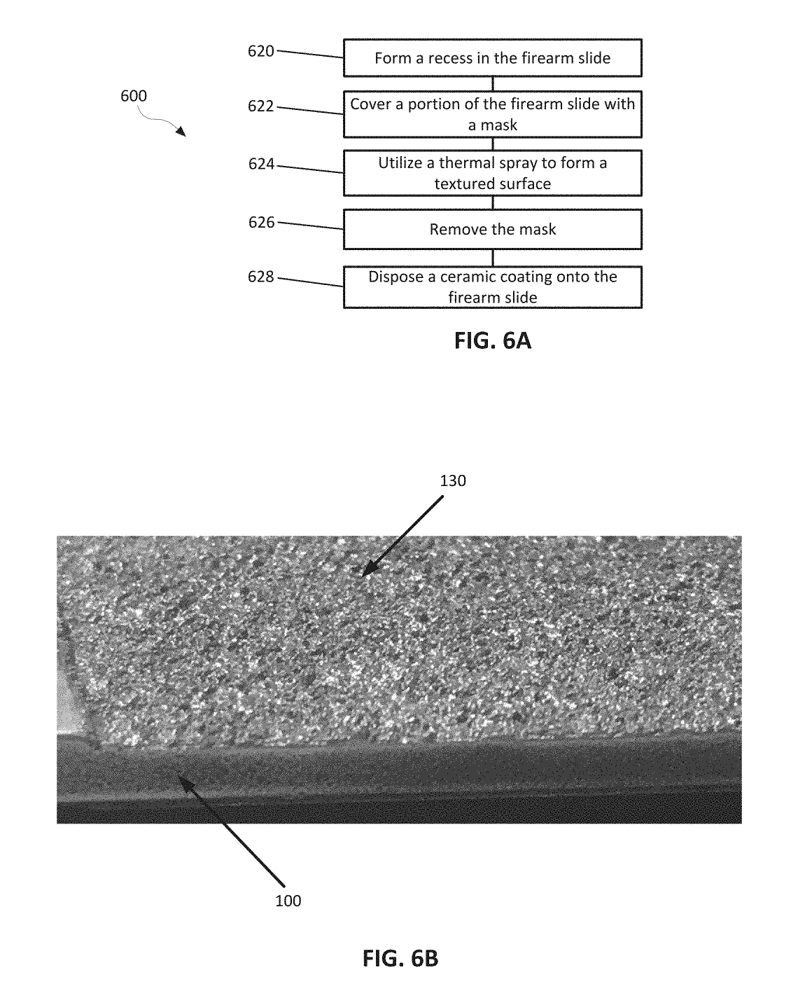

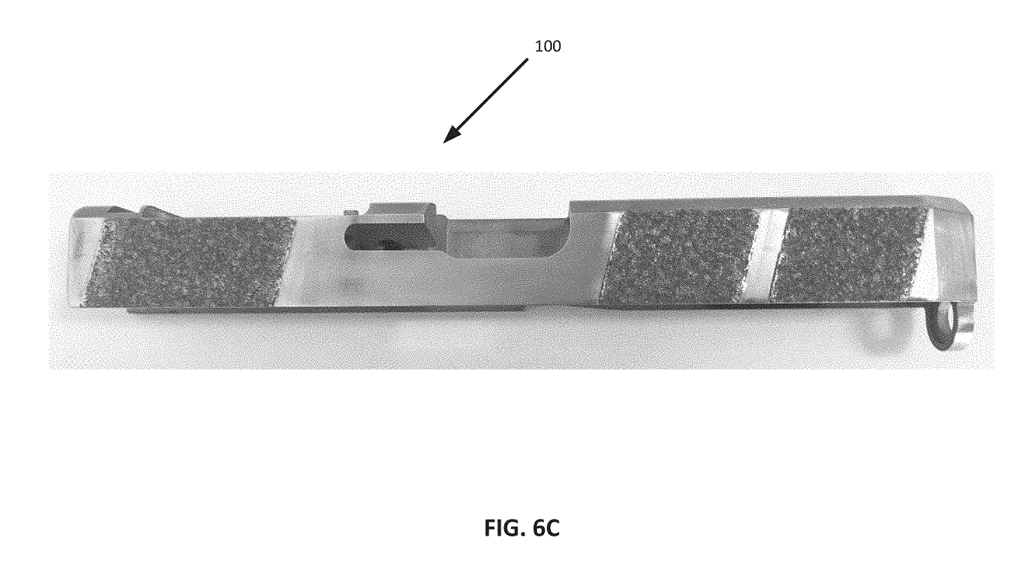

With reference now to FIGS. 6A and 6B, in various exemplary embodiments, principles of the present disclosure contemplate the use of a thermal spraying process (also known as “metallization”), for example, one or more of plasma spraying, detonation spraying, wire arc spraying, flame spraying, high-velocity oxy fuel coating spraying (HVOF), high velocity air fuel spraying, and/or the like. However, whereas in the past such processes have been utilized to provide mechanical coupling, corrosion protection, wear resistance, and/or the like (particularly at large and/or industrial scales), in various exemplary methods thermal spraying processes are utilized to form a textured surface on a portion or portions of an object, for example a firearm slide.

With reference now to FIG. 6A, a method 600 for texturing a metal surface by utilizing thermal spray is depicted, in accordance with various embodiments. In various embodiments, a recess may be formed in the metal surface (step 620). A portion or portions of the metal surface may be masked off or otherwise concealed, covered, or obstructed, for example via a stencil, template, screen, adhesive material, or the like (step 622). A thermal spray is then applied to the recess (step 624). Via the thermal spray, droplets of material are caused to adhere to and/or fuse or bond with the recess and/or with one another, resulting in a textured surface in the recess.

In various exemplary embodiments wherein a pistol slide is being textured, the thermal spray process may deposit molten droplets of stainless steel, for example 400 series stainless steel. Other suitable material or materials may be deposited via thermal spray, for example aluminum, zinc, bronze, low carbon steel, molybdenum, nickel alloys, and/or the like. Moreover, multiple layers or coats of thermal spray material may be deposited, and the multiple layers may be of the same or of differing materials.

In various exemplary embodiments, a thermal spray process may be manipulated to cause the surface to achieve a desired roughness. For example, a droplet size, nozzle movement speed, deposition material feed rate, deposition temperature, feed material, and/or the like may be selected and/or controlled to achieve a desired roughness.

Once the thermal spray process is complete, the mask or masks may be removed, leaving the desired textured surface behind (step 626). Thereafter, if desired, a portion or portions of the metal surface may be coated with a material such as a ceramic material (step 628). The coating material may be a firearm coating, for example a ceramic coating sold under the Cerakote® brand, a spray firearm coating sold under the DuraCoat® brand, paint, and/or other suitable coatings or adhesives.

With reference now to FIGS. 6B and 6C, in various exemplary embodiments a firearm slide 100 may be textured via application of texturing method 600. As can be seen in the cut-away view of FIG. 6B, the main body of firearm slide 100 is covered in a desired location with deposited material forming textured surface 130. In this manner, firearm slide 100 may be configured for improved user grip, ease of handling, and the like.

For example, in an exemplary embodiment, thermal spray is deposited into a recessed, unmasked portion of a firearm slide in order to create an area of roughened texture that is permanently bonded to the substrate; the resulting increase in surface area and texture greatly increases the coefficient of friction in the treated area. The deposited material may remain within the recessed area, and as such may remain below the main surface of the firearm slide. This ensures that the textured surface only interacts with objects placed within the recessed portion (for example, a finger or portion of a hand), and not with objects designed to contain the firearm slide (for example, a holster, firearm case, or the like).

In contrast to prior approaches for texturing a firearm slide, exemplary thermal spray processes offer significantly improved speed of deposition. Moreover, exemplary thermal spray processes offer improved anti-corrosive properties of the resulting textured area, depending on the deposited material (e.g., stainless steel). Yet further, exemplary thermal spray processes result in deposition of load bearing material with similar material structure and tensile strength as the target substrate, resulting in increased strength and durability of the treated part. Additionally, the resulting textured surfaces offer improved durability and wear resistance.

It will be appreciated that, in connection with texturing a firearm slide, a first portion of the slide may be textured with a first textured surface, and a second portion of the slide may be textured with a second textured surface having at least one characteristic different from the first textured surface, for example a greater or lesser surface roughness, depth or thickness of textured material, size of textured area, and/or the like. In this manner, a particular part (for example, a firearm slide) can be formed to accommodate and/or facilitate various handling techniques or systems. For example, a particular firearm slide may be textured in a manner to facilitate “press checks”, “over hand slide manipulation”, “under hand slide manipulation”, use of a barrier to manipulate the slide, and so forth.

Additionally, in various exemplary embodiments, one or more methods or processes disclosed herein may be utilized in combination with one another. For example, a particular firearm slide 100 may be textured via texturing method 600. Thereafter, one or more steps of method 500 may be applied to firearm slide 100, for example to textured surface 130, in order to further modify and/or control a desired level of roughness, a surface texture or pattern, and/or the like.

Exemplary systems and methods are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims.

No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for texturing a firearm slide, the method comprising:
forming a recess in a first surface on the firearm slide;
coupling a mask to the firearm slide to cover portions of the firearm slide beyond the recess;
applying a material to the recess via a thermal spray process to form a textured. surface in the recess; and
uncoupling the mask from the firearm slide.

2. The method of claim 1, wherein the material comprises stainless steel.

3. The method of claim 1, wherein the material comprises at least one of aluminum alloy, nickel alloy, or molybdenum.

4. The method of claim 1, further comprising disposing a ceramic coating onto at least a portion of the firearm slide.

5. The method of claim 1, wherein the mask is an adhesive mask.

6. The method of claim 1, wherein the thermal spray process comprises at least one of plasma spraying, detonation spraying, wire arc spraying, flame spraying, high-velocity oxy fuel coating spraying (HVOF), or high velocity air fuel spraying.

7. The method of claim 1, further comprising:
forming a second recess in a second surface on the firearm slide;
coupling a second mask to the firearm slide to cover portions of the firearm slide beyond the second recess;
applying a material to the second recess via a thermal spray process to form a second textured surface in the recess; and
uncoupling the second mask from the firearm slide, wherein the first textured surface and the second textured surface have a different coefficient of friction.

8. The method of claim 1, further comprising applying laser light to the textured surface to remove material from the textured surface.

9. The method of claim 1, further comprising coupling the firearm slide to a pistol.
